(19) United States
(12) Patent Application Publication
(10) Pub. No.: US 2021/0018000 A1
(43) Pub. Date: Jan. 21, 2021

(54) CIRCUIT ASSEMBLY FOR A SUBMERSIBLE PUMP AND SUBMERSIBLE PUMP USING THE SAME

(71) Applicant: Zhushi Tu, Xiaogan (CN)

(72) Inventor: Zhushi Tu, Xiaogan (CN)

(21) Appl. No.: 16/726,129

(22) Filed: Dec. 23, 2019

(30) Foreign Application Priority Data
Jul. 15, 2019 (CN) 201921104262.7

(51) Int. Cl. F04D 15/00; F04D 13/08; G01F 23/26; F04D 13/06

(52) U.S. Cl. CPC F04D 15/0077; F04D 13/0693; G01F 23/268; F04D 13/08

(57) ABSTRACT

A circuit assembly for a submersible pump and a submersible pump using the same are disclosed. The circuit assembly comprises: a control and signal generating circuit, which is configured to access a DC signal, and invert the DC signal into an AC signal and then output the AC signal; and a driving circuit, which is connected to the control and signal generating circuit, and is configured to receive the AC signal, and output AC power with corresponding frequency and voltage according to the AC signal to a stator coil of the submersible pump. The submersible pump can directly access DC power supply, which is very convenient for the user; and a water shortage protection circuit can be preferably configured to suspend the control and signal generating circuit when the liquid level is too low, so that a protection when the water level is too low is realized.

### CROSS REFERENCE TO RELATED APPLICATIONS

The present application claims the benefit of Chinese Patent Application No. 201921104262.7 filed on Jul. 15, 2019, the contents of which are incorporated herein by reference in its entirety.

### FIELD

The present application generally relates to submersible pumps, more particularly to a circuit assembly for a submersible pump and a submersible pump using the same.

### BACKGROUND

At present, most submersible pumps are directly connected to AC power supply. This power supply method has low working efficiency, and the power supply belongs to an AC linear power supply. The technology is backward, cumbersome and difficult to purchase. In other water pumps which work with DC power supply, mostly two sets of coils are wound in parallel and a Hall switch is used to switch the two sets of coils to work alternately, so that a pump rotor continues to rotate. But such structure is complicated, the cost is high, and a dead point is easy to occur, so that the pump can not work properly, reducing user experience.

### SUMMARY

The present application provides a circuit assembly for a submersible pump and a submersible pump using the same according to the aforementioned needs of the prior art.

According to one aspect of the present application, a circuit assembly for a submersible pump is provided, comprising: a control and signal generating circuit, which is configured to access a DC signal, and invert the DC signal into an AC signal and then output the AC signal; and a driving circuit, which is connected to the control and signal generating circuit, and is configured to receive the AC signal, and output AC power with corresponding frequency and voltage according to the AC signal to a stator coil of the submersible pump.

In one embodiment, the circuit assembly for a submersible pump further comprises a water shortage protection circuit, which is connected to the control and signal generating circuit, and is configured to monitor liquid level and output a liquid level protection signal to the control and signal generating circuit when the liquid level is lower than a preset liquid level to trigger the control and signal generating circuit being suspended. In one embodiment, the water shortage protection circuit comprises: a water shortage detecting probe whose sensing capacitance changes when it comes into contact with water; and a water level detecting circuit, which is connected to the water shortage detecting probe, and is configured to monitor the capacitance of the water shortage detecting probe to determine the liquid level, and output the liquid level protection signal when the liquid level is lower than the preset liquid level. In one embodiment, the water shortage detecting probe is made of copper or carbon fiber material.

In one embodiment, the control and signal generating circuit comprises: a logic control circuit, which is configured to control operation of the circuit assembly; and a signal generating circuit, which is connected to the driving circuit and the logic control circuit respectively, and is configured to access the DC signal, and invert the DC signal into the AC signal according to a frequency set by the logic control circuit, wherein the AC signal is a square wave signal, a triangular wave signal, a modified sine wave signal or a sine wave signal. In one embodiment, the signal generating circuit is an AC signal generator composed of a single chip microcomputer and peripheral components, or an AC signal generator composed of a 555 chip and peripheral components, or an AC signal generator composed of a digital gate circuit and peripheral components, or an AC signal generator composed of a transistor, resistors and capacitors.

In one embodiment, the driving circuit is composed of a motor-dedicated driver chip and its peripheral circuits, or is composed of a MOSFET tube or a triode or digital power amplifier components.

In one embodiment, the control and signal generating circuit further comprises: a switching circuit, which is connected to the logic control circuit, and is configured to acquire a switching signal input by a user and output the switching signal to the control and signal generating circuit to trigger start or shutdown of the control and signal generating circuit; and a prompting circuit, which is connected to the logic control circuit, and is configured to output corresponding prompt information after the logic control circuit is started.

According to another aspect of the present application, a submersible pump is provided, comprising any one of the circuit assemblies as mentioned above.

The circuit assembly for a submersible pump and the submersible pump using the same according to embodiments of the present application have the following beneficial effects: the submersible pump of the present application can directly access DC power supply, which is very convenient for the user; and further, the water shortage protection circuit can be preferably configured to suspend the control and signal generating circuit when the liquid level is too low, so that water pumping is no longer continued, and a protection when the water level is too low is realized.

### BRIEF DESCRIPTION OF THE DRAWINGS

In order to more clearly explain embodiments of the present application or technical solutions in the prior art, drawings used in the description of the embodiments or the prior art will be briefly introduced below. Obviously, the drawings in the following description are merely embodiments of the present application. For those of ordinary skill in the art, other drawings can be obtained according to the provided drawings without paying creative labor.

FIG. 1 is a circuit block diagram of a circuit assembly for a submersible pump of the present application;

FIG. 2 is a circuit diagram of a circuit assembly for a submersible pump according to a first embodiment of the present application;

FIG. 3 is a circuit diagram of a circuit assembly for a submersible pump according to a second embodiment of the present application.

### DETAILED DESCRIPTION

In order to facilitate understanding of the present application, the present application will be described more fully hereinafter with reference to the accompanying drawings. Exemplary embodiments of the present application are shown in the drawings. However, the present application may be embodied in many different forms and is not limited to the embodiments described herein. Rather, these embodiments are provided for the purpose of making a disclosure of the present application more comprehensive. It should be understood that the specific features of the embodiments and the embodiments of the present application are the detailed description of the technical solutions of the present application, and are not intended to limit the technical solutions of the present application, in the case of no conflict, the embodiments of the present application and the technical features in the embodiments can be combined with each other.

It should be noted that “connected” or “connected to” as used herein includes not only directly connecting two entities, but also indirectly connecting through other entities having beneficial improvement effects.

All technical and scientific terms used herein have the same meaning as commonly understood by one of ordinary skill in the art to the application. The terminology used in the description of the present application is for a purpose of describing particular embodiments and is not intended to limit the application.

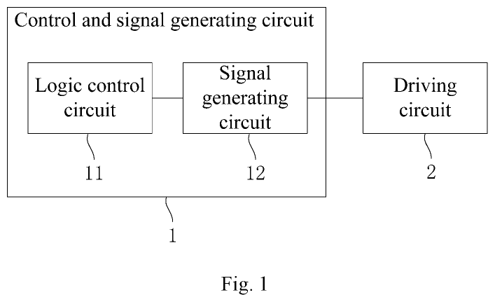

Referring to FIG. 1, a circuit block diagram of a circuit assembly for a submersible pump of the present application is shown. The circuit assembly for a submersible pump of the present application comprises:

a control and signal generating circuit 1, which is configured to access a DC signal, and invert the DC signal into an AC signal and then output the AC signal; and

a driving circuit 2, which is connected to the control and signal generating circuit, and is configured to receive the AC signal, and output AC power with corresponding frequency and voltage according to the AC signal to a stator coil of the submersible pump.

The control and signal generating circuit 1 comprises a logic control circuit 11 and a signal generating circuit 12. The logic control circuit 11 is configured to manage the entire circuit assembly. The signal generating circuit 12 is connected to the driving circuit 2 and the logic control circuit 11 respectively. The signal generating circuit 12 is configured to access the DC signal, and invert the DC signal into the AC signal according to a frequency set by the logic control circuit 11, and then output the AC signal.

The logic control circuit 11 and the signal generating circuit 12 may be separately designed. For example, the logic control circuit 11 may be a microcontroller, and the signal generating circuit 12 may be an AC signal generator composed of a single chip microcomputer and peripheral components, or an AC signal generator composed of a 555 chip and peripheral components, or an AC signal generator composed of a digital gate circuit and peripheral components, or an AC signal generator composed of a transistor, resistors and capacitors.

It can be understood that the logic control circuit 11 and the signal generating circuit 12 can also be integrated, for example, by using a chip design with inverter function to implement functions of both of the logic control circuit 11 and the signal generating circuit 12.

The following is a detailed description of three specific embodiments.

### Embodiment 1

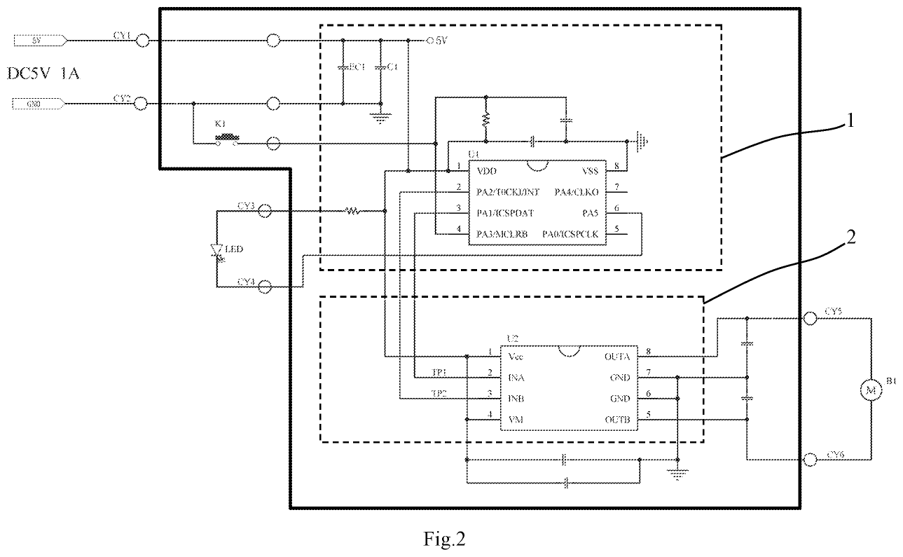

Referring to FIG. 2, the circuit assembly for a submersible pump in this embodiment comprises a control and signal generating circuit 1 and a driving circuit 2.

The control and signal generating circuit 1 is configured to access a DC signal, and invert the DC signal into an AC signal and then output the AC signal, wherein an output frequency of the AC signal is 40-200 Hz, and the AC signal includes but is not limited to a square wave signal, a triangular wave signal, a modified sine wave signal or a sine wave signal

The driving circuit 2 is connected to the control and signal generating circuit 1, and is configured to receive the AC signal, and output AC power with corresponding frequency and voltage according to the AC signal to a stator coil of the submersible pump.

Referring to FIG. 2, the control and signal generating circuit 1 of the present embodiment is realized by a microprocessor U1 and its peripheral circuits, and integrates functions of the above-described signal generating circuit 12 and logic control circuit 11. In this embodiment, the driving circuit 2 is composed of a motor-dedicated driver chip U2 and its peripheral circuits. Of course, it can be understood that in other embodiments, the driving circuit 2 may also be composed of a MOSFET tube or a triode or digital power amplifier components.

In this embodiment, it is preferable to further include a switching circuit and a prompting circuit.

The switching circuit is connected to the logic control circuit, and is configured to acquire a switching signal input by a user and output the switching signal to the control and signal generating circuit to trigger start or shutdown of the control and signal generating circuit. The switching circuit can use a common mechanical switch, such as K1 as shown in the figure.

The prompting circuit is connected to the logic control circuit, and is configured to output corresponding prompt information after the logic control circuit is started. The prompting circuit can adopt an acousto-optic prompt mode. In this embodiment, a LED light display mode is preferably used, such as an indicator LED in the figure.

The principle of this embodiment is as follows:

In FIG. 2, CY1 and CY2 are connected to the DC power supply, that is, the DC signal is obtained. CY3, CY4 are connected to the indicator LED. CY5 and CY6 are connected to the coil of the AC water pump B1. S1 is a water shortage detecting probe.

The microprocessor U1 plays a logical control role in the circuit assembly, and receives control of the switch K1 to turn the indicator LED on or off. At the same time, U1 can also generate AC signals of 40-100 Hz. The AC signal is output from TP1 and TP2 to the driver chip U2 to provide electrical signals. Therefore, U1 also functions as the AC signal generating circuit.

In the figure, the driver chip U2 receives the electrical signal output by U1 from TP1 and TP2, and provides sufficient driving current to the water pump coil through CY5 and CY6 ports. The water pump coil generates a rotating alternating magnetic field to drive a water pump rotor to run.

In the present embodiment, U1 is specifically used as FT60F011A, and U2 is specifically used as TC118S. It can be understood that selection of components in this embodiment is only an example, and is not intended to limit the present application.

### Embodiment 2

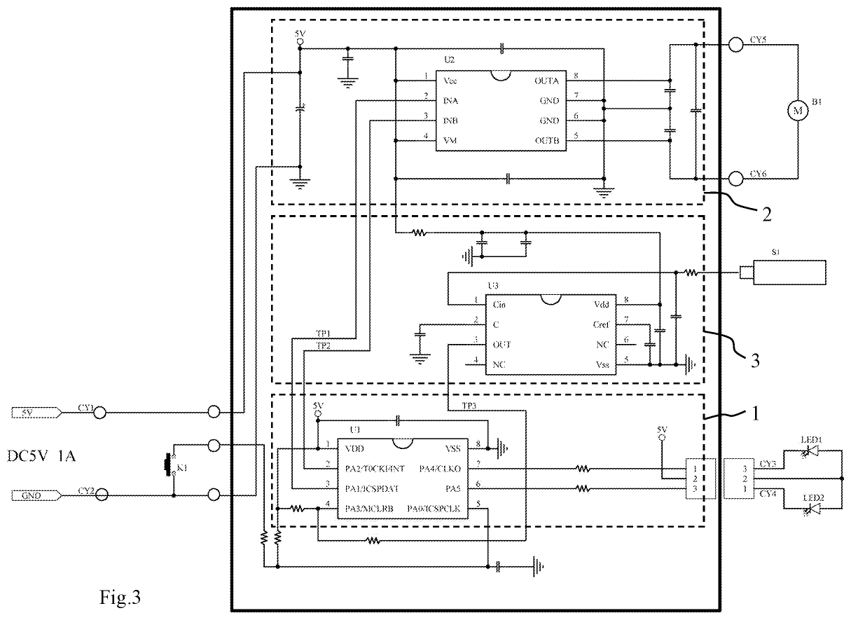

Referring to FIG. 3, a difference between this embodiment and the first embodiment is that a water shortage protection circuit is further preferably provided, and the water shortage protection circuit is connected to the control and signal generating circuit. The water shortage protection circuit is configured to monitor the liquid level and output a liquid level protection signal to the control and signal generating circuit 1 when the liquid level is lower than a preset liquid level to trigger the control and signal generating circuit 1 being suspended. Correspondingly, an indicator light can also be added to indicate the water shortage condition. For example, when the control and signal generating circuit 1 receives the liquid level protection signal, the operation is suspended on the one hand, so that the submersible pump no longer pumps water outside, and on the other hand, the indicator can be lighted to prompt the user.

Specifically, the water shortage protection circuit comprises a water shortage detecting probe and a water level detecting circuit 3.

The water shortage detecting probe has a sensing capacitance that changes when it comes into contact with water. The water shortage detecting probe is shown as Si in the figure, and the water detecting probe can be made of copper or carbon fiber material.

The water level detecting circuit 3 is connected to the water shortage detecting probe, and is configured to monitor the capacitance of the water shortage detecting probe to determine the liquid level, and output the liquid level protection signal when the liquid level is lower than the preset liquid level.

The principle of this embodiment is as follows:

In FIG. 3, CY1 and CY2 are connected to a DC power supply. CY3 and CY4 are connected to the indicators LED1 and LED2. CY5 and CY6 are connected to the coil of a AC synchronous water pump B1. S1 is a water shortage detecting probe.

A microprocessor U1 functions as a logic control in the circuit assembly, and receives control of a switch K1 to turn the indicator LED1 on or off. At the same time, U1 can also generate 10-100 Hz AC signal, output the AC signal from TP1 and TP2 to provide electric signal to a driver chip U2. Therefore, U1 also functions as the AC signal generating circuit. In the figure, the driver chip U2 receives the electrical signal output by U1 from TP1 and TP2, and provides sufficient driving current to the water pump coil through CY5 and CY6 ports. The water pump coil generates a rotating alternating magnetic field to drive a water pump rotor to run.

In the circuit diagram of this embodiment, U3 is a main chip of the water level detecting circuit 3. When the water level detecting probe is flooded, the water level detecting circuit 3 provides a signal representing having water to U1 through a TP3 point. When the probe is not submerged in water, the water level detecting circuit provides a signal representing no water to U1 through the TP3 point. U1 can receive the liquid level protection signals (TP3) provided by the water level detecting circuit 3, and control on/off of the indicator light LED2 to remind the user that the water level is too low, and when the water level is too low, AC signal (TP1, TP2) provided to the driver chip U2 is cut off, and the water pump B1 stops.

In addition, the present application also claims protection of a submersible pump using the circuit assembly as described above. The submersible pump comprises a housing, a control circuit board, an iron core, a stator, and the like. The control circuit board is provided with the circuit assembly as described above.

In the present embodiment, U1 is specifically used as FT60F011A, and U2 is specifically used as TC118S. It can be understood that selection of components in this embodiment is only an example, and is not intended to limit the present application.

In summary, the circuit assembly for a submersible pump and the submersible pump using the same according embodiments of the present application have the following beneficial effects: the submersible pump of the present application can directly access DC power supply, which is very convenient for the user; and further, the water shortage protection circuit can be preferably configured to suspend the control and signal generating circuit when the liquid level is too low, so that water pumping is no longer continued, and a protection when the water level is too low is realized.

The embodiments of the present application have been described above with reference to the drawings, but the present application is not limited to the specific embodiments described above, and the specific embodiments described above are merely illustrative and not restrictive. In the light of the scope of the present application, many forms may be made without departing from the scope of the present application, and these are all within protection of the present application.

What is claimed is:

1. A circuit assembly for a submersible pump, comprising:
a control and signal generating circuit, which is configured to access a DC signal, and invert the DC signal into an AC signal and then output the AC signal; and
a driving circuit, which is connected to the control and signal generating circuit, and is configured to receive the AC signal, and output AC power with corresponding frequency and voltage according to the AC signal to a stator coil of the submersible pump.

2. The circuit assembly for a submersible pump of claim 1, wherein the circuit assembly further comprises:
a water shortage protection circuit, which is connected to the control and signal generating circuit, and is configured to monitor liquid level and output a liquid level protection signal to the control and signal generating circuit when the liquid level is lower than a preset liquid level to trigger the control and signal generating circuit being suspended.

3. The circuit assembly for a submersible pump of claim 2, wherein the water shortage protection circuit comprises:
a water shortage detecting probe whose sensing capacitance changes when it comes into contact with water; and
a water level detecting circuit, which is connected to the water shortage detecting probe, and is configured to monitor the capacitance of the water shortage detecting probe to determine the liquid level, and output the liquid level protection signal when the liquid level is lower than the preset liquid level.

4. The circuit assembly for a submersible pump of claim 3, wherein the water shortage detecting probe is made of copper or carbon fiber material.

5. The circuit assembly for a submersible pump of claim 1, wherein the control and signal generating circuit comprises:
a logic control circuit, which is configured to control operation of the circuit assembly; and
a signal generating circuit, which is connected to the driving circuit and the logic control circuit respectively, and is configured to access the DC signal, and invert the DC signal into the AC signal according to a frequency set by the logic control circuit, wherein the AC signal is a square wave signal, a triangular wave signal, a modified sine wave signal or a sine wave signal.

6. The circuit assembly for a submersible pump of claim 5, wherein the signal generating circuit is an AC signal generator composed of a single chip microcomputer and peripheral components, or an AC signal generator composed of a 555 chip and peripheral components, or an AC signal generator composed of a digital gate circuit and peripheral components, or an AC signal generator composed of a transistor, resistors and capacitors.

7. The circuit assembly for a submersible pump of claim 5, wherein the control and signal generating circuit further comprises:
a switching circuit, which is connected to the logic control circuit, and is configured to acquire a switching signal input by a user and output the switching signal to the control and signal generating circuit to trigger start or shutdown of the control and signal generating circuit; and
a prompting circuit, which is connected to the logic control circuit, and is configured to output corresponding prompt information after the logic control circuit is started.

8. The circuit assembly for a submersible pump of claim 1, wherein the driving circuit is composed of a motor-dedicated driver chip and its peripheral circuits, or is composed of a MOSFET tube or a triode or digital power amplifier components.

9. A submersible pump, comprising a circuit assembly, wherein the circuit assembly comprises:
a control and signal generating circuit, which is configured to access a DC signal, and invert the DC signal into an AC signal and then output the AC signal; and
a driving circuit, which is connected to the control and signal generating circuit, and is configured to receive the AC signal, and output AC power with corresponding frequency and voltage according to the AC signal to a stator coil of the submersible pump.

10. The submersible pump of claim 9, wherein the circuit assembly further comprises:
a water shortage protection circuit, which is connected to the control and signal generating circuit, and is configured to monitor liquid level and output a liquid level protection signal to the control and signal generating circuit when the liquid level is lower than a preset liquid level to trigger the control and signal generating circuit being suspended.

11. The submersible pump of claim 10, wherein the water shortage protection circuit comprises:
a water shortage detecting probe whose sensing capacitance changes when it comes into contact with water; and
a water level detecting circuit, which is connected to the water shortage detecting probe, and is configured to monitor the capacitance of the water shortage detecting probe to determine the liquid level, and output the liquid level protection signal when the liquid level is lower than the preset liquid level.

12. The submersible pump of claim 11, wherein the water shortage detecting probe is made of copper or carbon fiber material.

13. The submersible pump of claim 9, wherein the control and signal generating circuit comprises:
a logic control circuit, which is configured to control operation of the circuit assembly; and
a signal generating circuit, which is connected to the driving circuit and the logic control circuit respectively, and is configured to access the DC signal, and invert the DC signal into the AC signal according to a frequency set by the logic control circuit, wherein the AC signal is a square wave signal, a triangular wave signal, a modified sine wave signal or a sine wave signal.

14. The submersible pump of claim 13, wherein the signal generating circuit is an AC signal generator composed of a single chip microcomputer and peripheral components, or an AC signal generator composed of a 555 chip and peripheral components, or an AC signal generator composed of a digital gate circuit and peripheral components, or an AC signal generator composed of a transistor, resistors and capacitors.

15. The submersible pump of claim 13, wherein the control and signal generating circuit further comprises:
a switching circuit, which is connected to the logic control circuit, and is configured to acquire a switching signal input by a user and output the switching signal to the control and signal generating circuit to trigger start or shutdown of the control and signal generating circuit; and
a prompting circuit, which is connected to the logic control circuit, and is configured to output corresponding prompt information after the logic control circuit is started.

16. The submersible pump of claim 9, wherein the driving circuit is composed of a motor-dedicated driver chip and its peripheral circuits, or is composed of a MOSFET tube or a triode or digital power amplifier components.
